(19) United States
(12) Patent Application Publication
(10) Pub. No.: US 2023/0165189 A1
(43) Pub. Date: Jun. 1, 2023

(54) QUICK-CONNECTING DEVICE FOR CABLE SUPPORT AND CABLE EXTRACTION FOR AGRICULTURAL BRUSHCUTTING OR CLEANING MACHINES

(71) Applicant: INDUSTRIAS DAVID S.L.U., Murcia (ES)

(72) Inventor: Javier LÓPEZ MARTÍNEZ, Murcia (ES)

(21) Appl. No.: 17/994,904

(22) Filed: Nov. 28, 2022

(30) Foreign Application Priority Data
Nov. 26, 2021 (ES) P202131100

(51) Int. Cl. A01D 34/416

(52) U.S. Cl. CPC A01D 34/4166; A01D 34/4165

(57) ABSTRACT

Cable support and extraction device for brushcutting machines, comprising a first part (1) with a first hollow shaft (1.1) for the connection of a drive shaft, a cover (3) and a side surface (4) with a through hole (5) and two diametrically opposed slots (6) for the passage of the ends of a cable (7); a second part (2) to fit inside the first part, with a second hollow shaft (2.1) hollow, allowing the passage of the first shaft (1.1) inside it and the winding of the cable (7) around it, between a first stop (8.1) with a flange (9) oriented towards a second stop (8.2) opposite; a retractable pin (10) in the flange (9), which has an engaged position in the hole (5) and a disengaged position for the free rotation of the second piece (2), and; means of actuating.

### CROSS REFERENCE TO RELATED APPLICATIONS

This application claims the benefit of Spanish Patent Application no. P202131100 filed on Nov. 26, 2021 (DAS CODE: 3DD9), which is incorporated herein by reference in its entirety.

### TECHNICAL FIELD OF THE INVENTION

The present invention corresponds to the technical field of agriculture, in particular to brushcutting or cleaning machines which operate on the ground by means of cables with a rotating movement around a drive shaft.

### BACKGROUND TO THE INVENTION

Nowadays, in the agricultural sector and specifically in the field of land clearing or cleaning, self-propelled machines or machines that can be coupled to tractors or other traction vehicles are increasingly used, which have a chassis and one or more heads, and which act on the area to be cleared by means of cables that rotate at high speed, so that the whips they generate produce a cleaning of the area. This brushcutting and cleaning mechanism is valid both in the open field and in the drip lines of crops planted in rows.

In this report, we understand cable to be any wire or filament used in these machines, which can be a metallic cable or any other type of cable, the most common being made of synthetic plastic material, such as nylon.

This cable, due to the friction it exerts on the ground and the material to be cleared, tends to suffer rapid wear and tear, which means that it needs to be changed frequently so that the machine can continue to perform its cleaning and clearing function.

The process of changing the cable is time-consuming and costly for the machine operator, as it requires a number of tools to do so. A spanner is usually needed to release the end of the machine's rotating shaft, to which the cable reel is attached, then the reel is removed and part of the cable is unwound. Finally, the reel has to be repositioned and locked to the shaft again, so that it can rotate with the shaft.

Other options require partially disassembling the head and inserting the filaments one by one and winding them using specific tools.

This process has to be repeated very often due to the rapid wear of the cable, which is an inconvenience for cleaning and clearing work, so it is necessary to find a way to replace the cable without it being so cumbersome and time-consuming.

### DESCRIPTION OF THE INVENTION

The quick connection device for cable support and extraction for agricultural brushcutting or cleaning machines presented here, for clearing by means of cables with a rotating movement around a drive shaft, comprises a first part with a first hollow shaft suitable for the connection inside it of the drive shaft.

This first part further comprises a cover at one end of the first shaft, and a side surface emerging from the cover which has a through hole and two diametrically opposed slots. Both grooves extend from the end opposite the cover to an intermediate section and allow the ends of a cable to pass through them.

The device also includes a second part suitable for fitting inside the first part and has a second hollow shaft that allows the first shaft to pass inside it.

Thus, the cable is wound around the second axis of this second part, between a first and a second stop which are fixed at the ends of this second axis. In addition, the first stop has a flange facing towards the second stop.

Furthermore, the device comprises a retractable pin arranged on the outer face of the flange, such that it has a position of engagement in the through hole for a fixed position of the second part in relation to the first part and a position disengaged from the through hole for a position where the second part can freely rotate inside the first part.

It also includes means for actuating the first part which pulls the second part through the retractable pin.

The proposed quick-connection device for cable support and extraction for agricultural brushcutting or cleaning machines represents a significant improvement on the state of the art.

This is because it provides a way to replace a worn cable without having to dismantle the machine in whole or in part to free a new cable end.

With this device, on the one hand, it is possible to wind up a large length of cable, which can be between 20 and 50 m or even more, depending on the model, and in this way, the cable can be unwound little by little, as it wears out, thus reducing machine downtime.

To unwind the cable, all you have to do is to press the retractable pin, which releases the second piece and allows it to turn with respect to the first piece, thus unwinding part of the cable, the ends of which come out through the grooves of the first piece. In this way, it is possible to have two new cable ends in perfect condition without having to dismantle any part of the machine, just by turning the second piece inside.

This results in significantly shorter cable replacement times, and also makes the process much easier for the operator, as no tools are required to carry it out.

When the cable is finished, the second piece can be replaced by another piece already pre-loaded with a coil of cable wound on its second axis or the second empty piece can be removed and a new cable wound on it.

It is therefore a very efficient device, which facilitates the operators work and significantly reduces cable change times.

### BRIEF DESCRIPTION OF THE DRAWINGS

In order to assist in a better understanding of the features of the invention, in accordance with a preferred example of a practical embodiment thereof, a series of drawings is provided as an integral part of this description, in which the following is shown for illustrative and non-limiting purposes:

FIG. 1.—Shows a perspective view of the first part of the quick connection device for cable support and extraction for agricultural brushcutting or cleaning machines, for a preferred embodiment of the invention.

FIG. 2.—Shows a perspective view of the second part of the quick connection device for cable support and extraction for agricultural brushcutting or cleaning machines, for a preferred embodiment of the invention.

FIG. 3.—Shows a perspective view of the quick connection device for cable support and extraction for agricultural brushcutting or cleaning machines, for a preferred embodiment of the invention.

FIG. 4.—Shows a perspective view of the quick connection device for cable support and cable extraction for agricultural brushcutting or cleaning machines, mounted with cable, for a preferred embodiment of the invention.

### DETAILED DESCRIPTION OF A PREFERRED EMBODIMENT OF THE INVENTION

In view of the figures provided, it can be seen how, in a preferred embodiment of the invention, the quick connection device for cable support and extraction for agricultural brushcutting or cleaning machines proposed here, for clearing or cleaning by means of cables with a rotating movement around a drive shaft, comprises a first part (1) comprising a first shaft (1.1) hollow, suitable for the connection of the drive shaft inside it, and a second part (2) suitable for fitting inside the first part (1), comprising a second hollow shaft (2.1) which allows the passage of the first shaft (1.1) inside it.

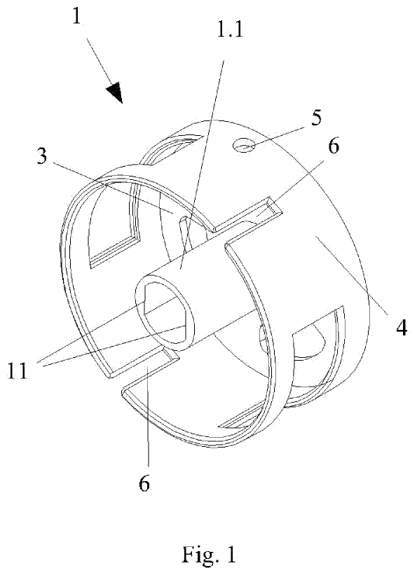

As shown in FIG. 1, the first part (1) further comprises a cover (3) at one end of the first shaft (1.1) and a side surface (4) emerging therefrom with a through hole (5) and two diametrically opposed slots (6), which extend from the end opposite the cover (3) to an intermediate section and allow the ends of a cable (7) to pass through them.

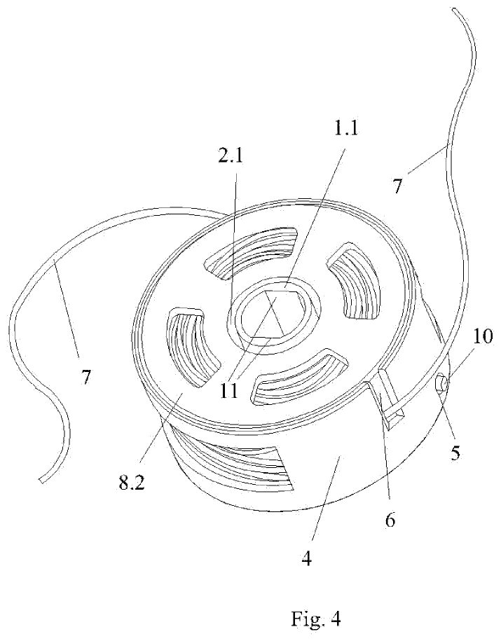

Likewise, and as can be seen in FIG. 4, the second shaft (2.1) also allows the winding of the cable (7) around it between a first and a second stop (8.1, 8.2) fixed at the ends of the second shaft (2.1) and, where the first stop (8.1) has a flange (9) oriented towards the second stop (8.2).

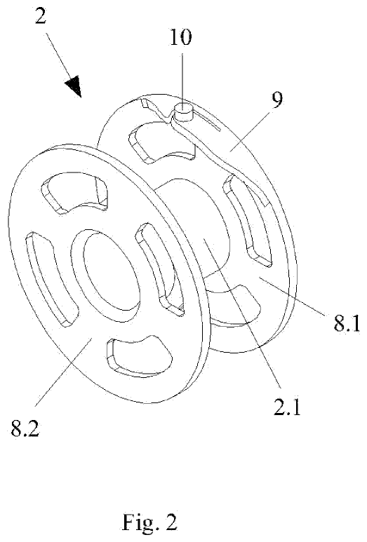

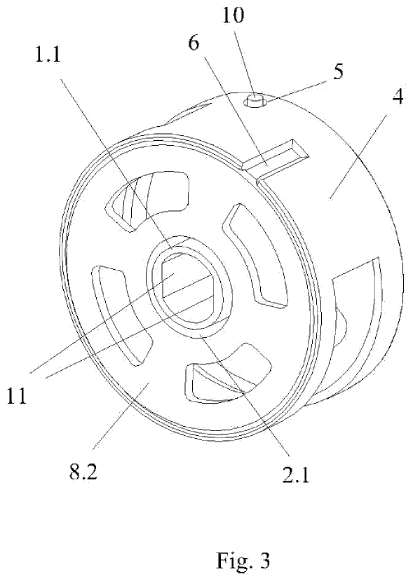

This device further comprises a retractable pin (10) arranged on the outer face of said flange (9), as can be seen in FIG. 2, such that it has a position of engagement in the through hole (5) for a fixed position of the second part (2) with respect to the first part, shown in FIG. 3, and a position disengaged from said hole (5), for a free rotating position of the second part (2) inside the first part (1).

It also has means for driving the first part (1) which pulls the second part (2) through the retractable pin (10) and which, in this embodiment, consists of an oil-hydraulic motor.

Thus, the cable (7) is wound onto the second part (2) and then the resulting assembly is inserted into the first part (1), so that the pin (10) is oriented towards the cover (3) of the first part (1), so that the pin (10) engages in the hole (5) of the cover (3) of the first part (1). The two ends of the cable (7) are extracted, each one through one of the slots (6) of the first part (1), as shown in FIG. 4, and the assembly is placed on the drive shaft.

As shown in FIG. 1, in this preferred embodiment of the invention, the first shaft (1.1) has means of attachment to the drive shaft which, in this case where the drive shaft has a lateral surface formed by flat faces, are formed by at least two flat faces (11) on the inner surface of the first shaft (1.1).

In order to unwind the cable (7), the process consists of pressing the pin (10), so that it disengages from the hole (5) and allows the second part (2) to rotate inside and relative to the first part (1), at the same time as the cable (7) is being unwound.

When the second part (2) has been turned once more, the pin (10) reaches the height of the hole (5) and snaps back into the hole, thus locking the cable (7) and preventing it from unwinding further.

If a longer length of wire (7) is required, the process is simply repeated and the same length of wire (7) is unwound again after one complete turn of the second piece (2).

In this preferred embodiment of the invention, the hole (5) of the first part (1) is arranged close to the cover (3) of the same.

Moreover, in this preferred embodiment, the flange (9) of the second part (2) is perpendicular to the first stop (8.1) and is arranged at least on a part of the contour of the first stop (8.1).

In one example, a quick coupling device for cable support and cable extraction for agricultural brushcutting or cleaning machines, for clearing by means of cables (7) with a rotating movement around a drive shaft, includes a first part (1) comprising a first hollow shaft (1.1) suitable for the connection inside it of the drive shaft, a cover (3) at one end of the first shaft (1.1), and a side surface (4) emerging therefrom with a through hole (5) and two diametrically opposed slots (6), which extend from the end opposite the cover (3) to an intermediate section and allow the ends of a cable (7) to pass through them. The quick coupling device further includes a second part (2) suitable for fitting inside the first part (1), comprising a second hollow shaft (2.1), which allows the passage of the first shaft (1.1) inside it and the winding of the cable (7) around it, between a first and a second stop (8.1, 8.2) fixed at the ends of the second shaft (2.1), where the first stop (8.1) has a flange (9) facing the second stop (8.2). The quick coupling device further includes a retractable pin (10) arranged on the outer face of the flange (9), such that it has a position of engagement in the through hole (5) for a fixed position of the second part (2) in relation to the first part (1) and a position disengaged from the through hole (5), for a free rotating position of the second part (2) inside the first part (1). The quick coupling device further includes a means of actuating the first part (1) which pulls the second part (2) through the retractable pin (10).

In another example, the quick coupling device for cable support and cable extraction for agricultural brushcutting or cleaning machines as described above may further include a device wherein the first shaft (1.1) has means of attachment to the drive shaft. This quick coupling device may further include a device wherein the drive shaft has a lateral surface formed by flat faces and the means of attachment the first shaft (1.1) to the said drive shaft are formed by at least one flat face (11) on the inner surface of the first shaft (1.1).

In any of the examples described above, the quick coupling device for cable support and cable extraction for agricultural brushcutting or cleaning machines may further include a device wherein the hole (5) of the first part (1) is arranged close to the cover (3) thereof.

In any of the examples described above, the quick coupling device for cable support and cable extraction for agricultural brushcutting or cleaning machines may further include a device wherein the flange (9) is perpendicular to the first stop (8.1) and is arranged at least on a part of the contour thereof.

1. Quick coupling device for cable support and cable extraction for agricultural brushcutting or cleaning machines, for clearing by means of cables (7) with a rotating movement around a drive shaft, comprising:
a first part (1) comprising a first hollow shaft (1.1) suitable for the connection inside it of the drive shaft, a cover (3) at one end of the first shaft (1.1), and a side surface (4) emerging therefrom with a through hole (5) and two diametrically opposed slots (6), which extend from the end opposite the cover (3) to an intermediate section and allow the ends of a cable (7) to pass through them;
a second part (2) suitable for fitting inside the first part (1), comprising a second hollow shaft (2.1), which allows the passage of the first shaft (1.1) inside it and the winding of the cable (7) around it, between a first and a second stop (8.1, 8.2) fixed at the ends of the second shaft (2.1), where the first stop (8.1) has a flange (9) facing the second stop (8.2);
a retractable pin (10) arranged on the outer face of the flange (9), such that it has a position of engagement in the through hole (5) for a fixed position of the second part (2) in relation to the first part (1) and a position disengaged from the through hole (5), for a free rotating position of the second part (2) inside the first part (1), and;
means of actuating the first part (1) which pulls the second part (2) through the retractable pin (10).

2. Device according to claim 1, wherein the first shaft (1.1) has means of attachment to the drive shaft.

3. Device according to claim 2, wherein the drive shaft has a lateral surface formed by flat faces and the means of attachment the first shaft (1.1) to the said drive shaft are formed by at least one flat face (11) on the inner surface of the first shaft (1.1).

4. Device according to claim 1, wherein the hole (5) of the first part (1) is arranged close to the cover (3) thereof.

5. Device according to claim 1, wherein the flange (9) is perpendicular to the first stop (8.1) and is arranged at least on a part of the contour thereof.
